(19) United States
(12) Patent Application Publication
(10) Pub. No.: US 2020/0125488 A1
(43) Pub. Date: Apr. 23, 2020

(54) MEMORY SYSTEM AND OPERATING METHOD THEREOF

(71) Applicant: SK hynix Inc., Gyeonggi-do (KR)

(72) Inventor: Eu-Joon BYUN, Gyeonggi-do (KR)

(21) Appl. No.: 16/408,161

(22) Filed: May 9, 2019

(30) Foreign Application Priority Data
Oct. 19, 2018 (KR) 10-2018-0125258

(51) Int. Cl. G06F 12/02; G06F 12/10; G06F 12/12

(52) U.S. Cl. CPC G06F 12/0253; G06F 12/10; G06F 2212/657; G06F 2212/1044; G06F 12/12

(57) ABSTRACT

A memory system includes: a memory device; a logical address detector suitable for detecting logical addresses corresponding to physical addresses of valid data stored in a victim block based on physical-to-logical address information; a sorter suitable for arranging the detected logical addresses in a specific order; and a garbage collection module suitable for controlling the memory device to perform a garbage collection operation by sequentially programming the valid data into a target block according to the arranged logical addresses.

### CROSS-REFERENCE TO RELATED APPLICATION

The present application claims priority under 35 U.S.C. § 119(a) to Korean Patent Application No. 10-2018-0125258, filed on Oct. 19, 2018, which is incorporated herein by reference in its entirety.

### BACKGROUND

### 1. Field

Various embodiments of the present invention relate to a memory system, and more particularly, to a memory system that may efficiently perform a garbage collection operation, and a method for operating the memory system.

### 2. Description of the Related Art

The computer environment paradigm has shifted to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption since they have no moving parts, as compared with a hard disk device. Examples of memory systems having such advantages include universal serial bus (USB) memory devices, memory cards having various interfaces, and solid state drives (SSD).

### SUMMARY

Embodiments of the present invention are directed to a memory system capable of arranging valid data of victim memory block(s) in an order of logical addresses while performing a garbage collection operation on the victim memory block(s).

In accordance with an embodiment of the present invention, a memory system includes: a memory device; a logical address detector suitable for detecting logical addresses corresponding to physical addresses of valid data stored in a victim block based on physical-to-logical address information; a sorter suitable for arranging the detected logical addresses in a specific order; and a garbage collection module suitable for controlling the memory device to perform a garbage collection operation by sequentially programming the valid data into a target block according to the arranged logical addresses.

In accordance with another embodiment of the present invention, a method for operating a memory system includes: detecting logical addresses corresponding to physical addresses of valid data stored in a victim block based on physical-to-logical address information; arranging the detected logical addresses in a specific order; and performing a garbage collection operation by sequentially programming the valid data into a target block according to the arranged logical addresses.

In accordance with another embodiment of the present invention, a memory system includes: a memory device including a victim block and a target block; and a controller configured to: arrange logical addresses of valid data stored in the victim block in a specific order while reading the valid data from the victim block; and control the memory device to sequentially program the valid data into the target block according to the arranged logical addresses.

### BRIEF DESCRIPTION OF THE DRAWINGS

FIG. 1 is a block diagram illustrating a data processing system including a memory system in accordance with an embodiment of the present invention.

FIG. 2 is a diagram schematically illustrating a data processing operation on a memory device in the memory system in accordance with an embodiment of the present disclosure.

FIG. 3 is a diagram illustrating a basic garbage collection operation.

FIG. 4 is a flowchart describing a conventional garbage collection operation.

FIGS. 5A and 5B are diagrams illustrating an operation of programming valid data according to prior art.

FIG. 6 is a flowchart describing an operation of a memory system in accordance with an embodiment of the present invention.

FIG. 7 is a flowchart describing an address information update operation in detail.

FIGS. 8A and 8B are diagrams illustrating an operation of programming valid data in accordance with an embodiment of the present invention.

FIG. 9 is a block diagram illustrating a memory system in accordance with an embodiment of the present invention.

FIG. 10 is a block diagram illustrating an address updater in detail.

FIG. 11 is a schematic diagram illustrating an exemplary configuration of a memory device employed in a memory system, such as that shown in FIG. 1.

FIG. 12 is a circuit diagram illustrating an exemplary configuration of a memory cell array of a memory block in a memory device, such as that shown in FIG. 1.

FIG. 13 is a block diagram illustrating a structure of a memory device of a memory system in accordance with an embodiment of the present invention.

FIGS. 14 to 22 are diagrams schematically illustrating exemplary applications of the data processing system in accordance with various embodiments of the present invention.

### DETAILED DESCRIPTION

Various embodiments of the present invention are described below in more detail with reference to the accompanying drawings. The present invention may, however, be embodied in different forms and should not be construed as limited to the embodiments set forth herein. Rather, these embodiments are provided so that this disclosure is thorough and complete and fully conveys the scope of the present invention to those skilled in the art. Throughout the disclosure, like reference numerals refer to like parts throughout the various figures and embodiments of the present invention.

It is noted that reference to “an embodiment,” “another embodiment” or the like does not necessarily mean only one embodiment, and different references to any such phrase are not necessarily to the same embodiment(s).

It will be understood that, although the terms “first” and/or “second” may be used herein to identify various elements, these elements should not be limited by these terms. These terms are only used to distinguish one element from another element that otherwise have the same or similar names. For instance, a first element discussed below could be termed a second element, and vice versa, without departing from the teachings of the present disclosure.

It will be understood that when an element is referred to as being “coupled” or “connected” to another element, it can be directly coupled or connected to the other element or one or more intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or “directly adjacent to” should be construed in the same way.

The terminology used herein is for the purpose of describing particular embodiments only and is not intended to be limiting. In the present disclosure, the singular forms are intended to include the plural forms as well, unless the context clearly indicates otherwise. It will be further understood that open-ended terms, such as “comprise”, “include”, “have”, when used in this specification, specify the presence of stated features, numbers, steps, operations, elements, components, and/or combinations of them but do not preclude the presence or addition of one or more other features, numbers, steps, operations, elements, components, and/or combinations thereof.

The embodiments disclosed herein are merely for the purpose of understanding the technical spirit of the present disclosure; however, the scope of the present invention should not be limited to the disclosed embodiments. It will be apparent to those skilled in the relevant art in light of the present disclosure that modifications within the technical spirit and scope of the present disclosure may be made to any of the disclosed embodiments.

Unless otherwise defined, all terms including technical and scientific terms used herein have the same meaning as commonly understood by one of ordinary skill in the art to which the present disclosure belongs. Unless otherwise defined in the present disclosure, the terms should not be construed as being ideal or excessively formal.

Various embodiments of the present invention are described in detail below with reference to the accompanying drawings.

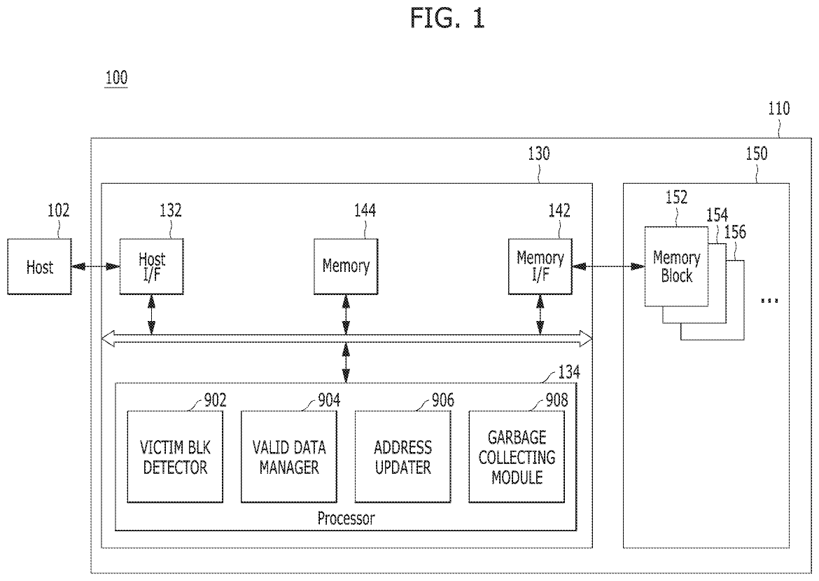

FIG. 1 is a block diagram illustrating a data processing system 100 including a memory system 110 in accordance with an embodiment of the present invention.

Referring to FIG. 1, the data processing system 100 may include a host 102 operatively coupled to the memory system 110.

The host 102 may include any of a variety of portable electronic devices such as a mobile phone, a MP3 player and a laptop computer, or any of a variety of non-portable electronic devices such as a desktop computer, a game machine, a TV and a projector.

The host 102 may include at least one OS (operating system). The host 102 may execute an OS to perform an operation corresponding to a user's request on the memory system 110. Here, the host 102 may provide a plurality of commands corresponding to a user's request to the memory system 110. Thus, the memory system 110 may perform certain operations corresponding to the plurality of commands, that is, corresponding to the user's request. The OS may manage and control overall functions and operations of the host 102. The OS may support an operation between the host 102 and a user using the data processing system 100 or the memory system 110.

The memory system 110 may operate or perform a specific function or operation in response to a request from the host 102 and, particularly, may store data to be accessed by the host 102. The memory system 110 may be used as a main memory system or an auxiliary memory system of the host 102. The memory system 110 may be implemented with any of various types of storage devices, which may be electrically coupled with the host 102, according to a protocol of a host interface. Non-limiting examples of the memory system 110 include a solid state drive (SSD), a multi-media card (MMC) and an embedded MMC (eMMC).

The memory system 110 may include various types of storage devices. Non-limiting examples of such storage devices include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM), and a flash memory.

The memory system 110 may include a memory device 150 and a controller 130.

The controller 130 and the memory device 150 may be integrated into a single semiconductor device, which may be included in any of the various types of memory systems as described above. For example, the controller 130 and the memory device 150 may be integrated as a single semiconductor device to constitute an SSD, a PCMCIA (personal computer memory card international association) card, SD card including a mini-SD, a micro-SD and a SDHC, and an UFS device. The memory system 110 may be configured as a part of a computer, a smart phone, a portable game player, or one of various components configuring a computing system.

The memory device 150 may be a nonvolatile memory device which may retain stored data even though power is not supplied. The memory device 150 may store data provided from the host 102 through a write operation, and output data stored therein to the host 102 through a read operation. In an embodiment, the memory device 150 may include a plurality of memory dies (not shown), and each memory die may include a plurality of planes (not shown). Each plane may include a plurality of memory blocks 152 to 156, each of which may include a plurality of pages, each of which may include a plurality of memory cells coupled to a word line. In an embodiment, the memory device 150 may be a flash memory having a 3-dimensional (3D) stack structure.

A structure of the memory device 150 including a three-dimensional stereoscopic stacked structure of the memory device 150 is described more in detail below with reference to FIGS. 11 to 13.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

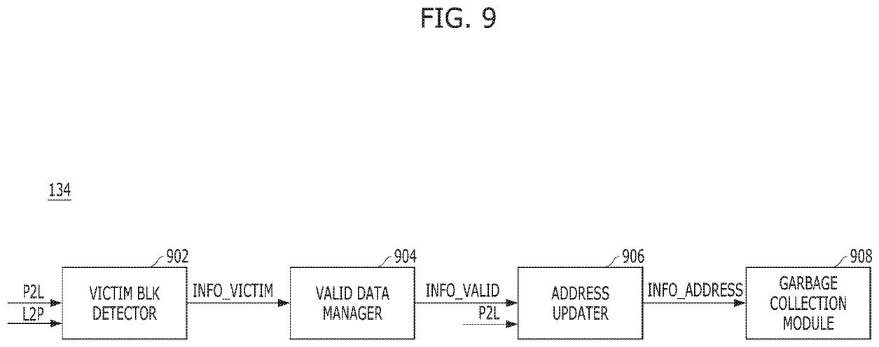

More specifically, the controller 130 may include a host interface (I/F) 132, a processor 134, a memory interface 142, and a memory 144, all operatively coupled or engaged via an internal bus. As to be described later with reference to FIG. 9, the processor 134 may include a victim block detector 902, a valid data manager 904, an address updater 906, and a garbage collection module 908.

The host interface 132 may process a command and data of the host 102. The host interface 132 may communicate with the host 102 through one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI) and integrated drive electronics (IDE). The host interface 132 may be driven via a firmware, that is, a host interface layer (HIL) for exchanging data with the host 102.

The memory interface 142 may serve as a memory/storage interface between the controller 130 and the memory device 150 such that the controller 130 may control the memory device 150 in response to a request from the host 102.

The memory 144 may serve as a working memory of the memory system 110 and the controller 130, and store data for driving the memory system 110 and the controller 130.

The memory 144 may be a volatile memory. For example, the memory 144 may be a static random access memory (SRAM) or dynamic random access memory (DRAM). The memory 144 may be disposed within or external to the controller 130. FIG. 1 shows the memory 144 disposed within the controller 130. In another embodiment, the memory 144 may be an external volatile memory having a memory interface for transferring data between the memory 144 and the controller 130.

As described above, the memory 144 may include a program memory, a data memory, a write buffer/cache, a read buffer/cache, a data buffer/cache and a map buffer/cache to store some data to perform data write and read operations between the host 102 and the memory device 150 and other data for the controller 130 and the memory device 150 to perform these operations.

The processor 134 may control overall operations of the memory system 110. The processor 134 may use firmware to control the overall operations of the memory system 110. The firmware may be referred to as flash translation layer (FTL). The processor 134 may be implemented with a microprocessor or a central processing unit (CPU).

For example, the controller 130 may perform an operation requested by the host 102 in the memory device 150 through the processor 134. Also, the controller 130 may perform a background operation on the memory device 150 through the processor 134. The background operation performed on the memory device 150 may include an operation of copying and processing data stored in some memory blocks among the memory blocks 152 to 156 into other memory blocks, e.g., a garbage collection (GC) operation, an operation of swapping data among some of the memory blocks, e.g., a wear-leveling (WL) operation, an operation of storing the map data stored in the controller 130 in the memory blocks 152 to 156, e.g., a map flush operation, or an operation of managing bad blocks of the memory device 150, e.g., a bad block management operation of detecting and processing bad blocks among the memory blocks 152 to 156 in the memory device 150.

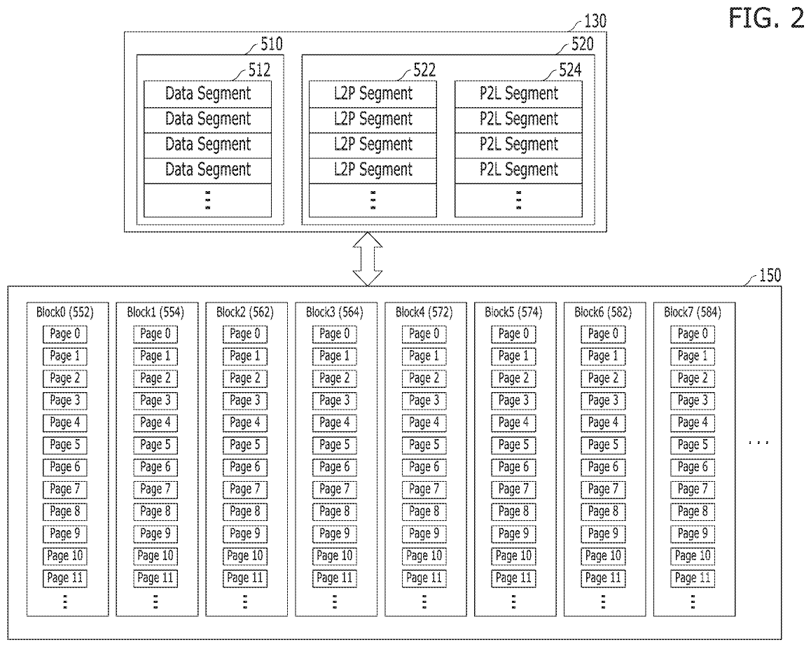

FIG. 2 is a diagram schematically illustrating a data processing operation of a memory system to a memory device in accordance with an embodiment of the present invention.

Referring to FIG. 2, the controller 130 may receive a program command, program data and logical addresses from the host 102. The controller 130 programs and stores the program data in the plurality of pages included in memory blocks 552, 554, 562, 564, 572, 574, 582 and 584 of the memory device 150, in response to the program command.

The controller 130 generates and updates metadata for the program data, and programs and stores the metadata in the memory blocks 552, 554, 562, 564, 572, 574, 582 and 584 of the memory device 150. The metadata include logical/physical (L2P: logical to physical) information and physical/logical (P2L: physical to logical) information for the program data stored in the memory blocks 552, 554, 562, 564, 572, 574, 582 and 584. Also, the metadata may include information on command data corresponding to a command received from the host 102, information on a command operation corresponding to the command, information on the memory blocks of the memory device 150 for which the command operation is to be performed, and information on map data corresponding to the command operation. In other words, metadata may include all remaining information and data except program data corresponding to a command received from the host 102.

The logical/physical (L2P: logical to physical) information and the physical/logical (P2L: physical to logical) information mean information in which physical addresses corresponding to the logical addresses are mapped by the controller 130 in response to the program command. The physical addresses may correspond to physical storage spaces of the memory device 150 where the program data received from the host 102 are to be stored.

The controller 130 may store the mapping information between the logical addresses and the physical addresses, that is, the logical/physical (L2P: logical to physical) information and the physical/logical (P2L: physical to logical) information, in at least one memory block among the memory blocks 552, 554, 562, 564, 572, 574, 582 and 584 of the memory device 150. The at least one memory block which stores the logical/physical (L2P: logical to physical) information and the physical/logical (P2L: physical to logical) information may be referred to as a system block.

For example, the controller 130 caches and buffers the program data corresponding to the program command received from the host 102 in a first buffer 510 included in the memory 144 of the controller 130, that is, stores data segments 512 of user data in the first buffer 510 as a data buffer/cache. Thereafter, the controller 130 programs and stores the data segments 512 stored in the first buffer 510 in the pages included in the memory blocks 552, 554, 562, 564, 572, 574, 582 and 584 of the memory device 150.

As the data segments 512 of the program data are programmed and stored in the pages included in the memory blocks 552, 554, 562, 564, 572, 574, 582 and 584, the controller 130 generates L2P segments 522 and P2L segments 524 as metadata, and stores them in a second buffer 520 included in the memory 144 of the controller 130. In the second buffer 520, the L2P segments 522 and the P2L segments 524 may be stored in the form of a list. Then, the controller 130 may program and store the L2P segments 522 and the P2L segments 524 stored in the second buffer 520 in the pages included in the memory blocks 552, 554, 562, 564, 572, 574, 582 and 584 of the memory device 150, through a map flush operation.

Also, the controller 130 may receive a read command and logical addresses from the host 102. The controller 130 may read L2P segments 522 and P2L segments 524 corresponding to the logical addresses of the host 102 from the memory device 150 and load them in the second buffer 520, in response to the read command. Then, the controller 130 checks physical addresses of the memory device 150 corresponding to the logical addresses of the host 102 from the L2P segments 522 and the P2L segments 524 loaded in the second buffer 520, reads data segments 512 of user data from storage positions known through the checking, that is, specific pages of specific memory blocks among the memory blocks 552, 554, 562, 564, 572, 574, 582 and 584, stores the data segments 512 in the first buffer 510, and provides the data segments 512 to the host 102.

As described above, each time a read command and logical addresses are received from the host 102, the controller 130 may read L2P segments 522 and P2L segments 524 corresponding to the logical addresses of the host 102, and load them in the second buffer 520. As the operation of loading L2P segments 522 and P2L segments 524 in this way is repeated frequently, it may serve as a cause that degrades the read performance of the memory system 110.

The more space of the second buffer 520 that is secured, the more L2P segments 522 and P2L segments 524 the controller 130 may load from the memory device 150 at a time. As a result, even by one loading operation for L2P segments 522 and P2L segments 524, it is possible to process a plurality of read commands. Through this, the read performance of the memory system 110 may be improved.

L2P segments may be optimized to search physical addresses corresponding to specific logical addresses, and, as a result, may be efficient in searching physical addresses to be mapped to logical addresses inputted from the host 102, in a read operation.

Also, P2L segments 524 may be optimized for a program operation. The controller 130 may need to quickly allocate storage spaces in the memory device 150 for storing program data, when receiving a program command, program data and logical addresses from the host 102. In this regard, the controller 130 may load in advance a list of physical addresses corresponding to storage spaces in the memory device 150 which may be newly allocated, in the second buffer 520. Therefore, at a time when the program command, the program data and the logical addresses are received from the host 102, the controller 130 may quickly search the list of physical addresses loaded in the second buffer 520, may map physical addresses corresponding to storages spaces capable of storing the program data with the logical addresses, and may then store the program data in the storage spaces corresponding to the physical addresses. At this time, P2L segments 524 may be generated and temporarily stored in the second buffer 520. The P2L segments 524 stored in the second buffer 520 may be stored in the memory device 150 through a map flush operation.

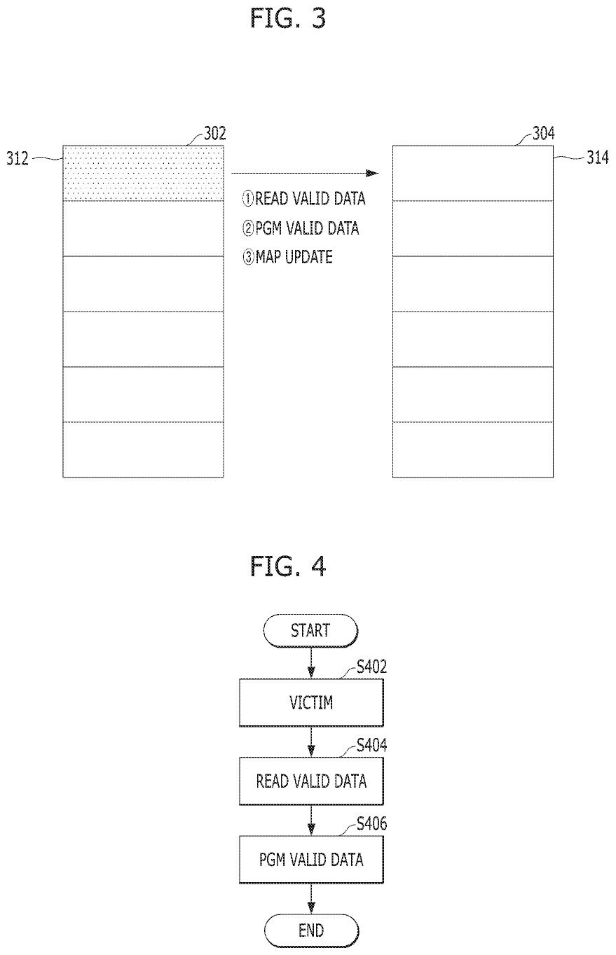

FIG. 3 illustrates a basic garbage collection operation.

The flash memory may perform a program operation and a read operation on a page basis, perform an erase operation on a block basis, and does not support an overwrite operation unlike a hard disk. Therefore, the flash memory may correct the original data programmed in a page by programming modified data into a new page and invalidating the page of the original data.

The garbage collection operation may be an operation of periodically converting the invalidated page into a blank page in order to prevent the flash memory space from being wasted due to the invalidated page in the process of modifying the data. The garbage collection operation may include a valid data read operation for reading the data programmed in a valid page 312 of a victim block 302, a valid data program operation for programming the valid data into a blank page 314 of a target block 304, and a map update operation for updating address information (map information) of the valid data.

FIG. 4 is a flowchart describing a garbage collection operation according to prior art.

In step S402, the controller 130 detects victim blocks VICTIM among a plurality of memory blocks in the memory device 150. For example, the controller 130 detects memory blocks having a number of valid pages less than a threshold value as the victim blocks VICTIM. The controller 130 stores address information on the detected victim blocks VICTIM in the memory 144. Also, the controller 130 performs a control to perform a check-pointing operation of periodically programming the address information on the detected victim blocks VICTIM stored in the memory 144 into a memory block, which is a non-volatile memory in preparation for the occurrence of a Sudden Power-Off (SPO).

In step S404, the controller 130 performs a control to read the valid data VALID DATA of the victim blocks VICTIM that are detected in the step S402. The controller 130 performs a control to read the valid data VALID DATA stored in the victim blocks VICTIM to be read in an ascending order of physical addresses. For example, the controller 130 performs a control to read the valid data from a uppermost page, that is, a page having the smallest physical address value, to a lowermost page, that is, a page having the largest physical address value, among a plurality of pages included in each of the victim blocks VICTIM. The controller 130 stores the read valid data VALID DATA into the memory 144.

As described above with reference to FIG. 2, the controller 130 performs a control to perform a valid data read operation based on logical-to-physical (L2P) information and physical-to-logical (P2L) information for the valid data. For example, the controller 130 detects the logical addresses of the data by referring to the physical-to-logical (P2L) information in order to determine the validity of the data stored in a specific physical address. When the physical addresses corresponding to the detected logical addresses are the same as the specific physical addresses in which the data are stored based on the logical-to-physical (L2P) information, the controller 130 determines that the data are valid.

In step S406, the controller 130 performs a control to program the valid data VALID DATA that is read in the step S404 into a target block. According to the prior art, the controller 130 performs a control to program the valid data VALID DATA into the target block according to the order that the valid data VALID DATA are read. As described above in the step S404, the controller 130 performs a control to read the valid data VALID DATA stored in the victim blocks VCITIM in an ascending order of physical addresses. Therefore, the controller 130 programs the valid data VALID DATA of the victim blocks VICTIM into the target block in the ascending order of not the logical addresses but the physical addresses of the valid data VALID DATA.

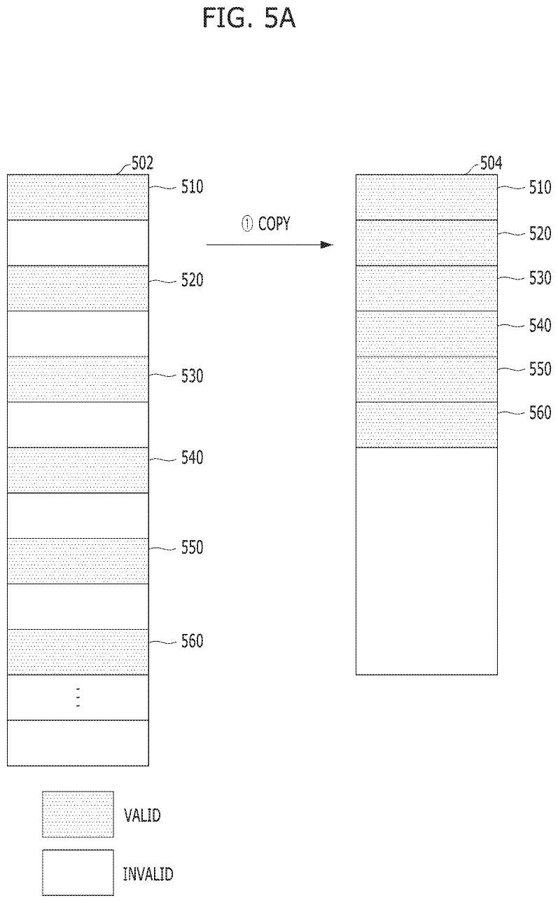

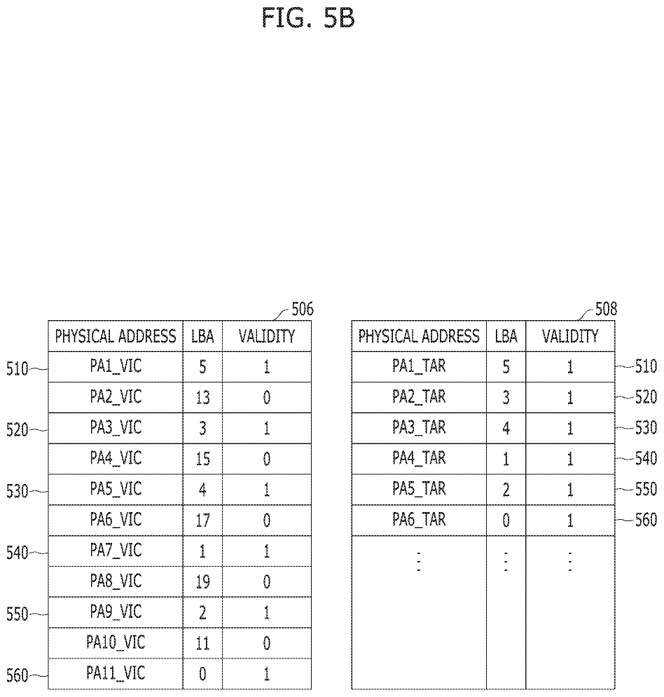

FIGS. 5A and 5B illustrate an operation of programming valid data according to the prior art.

As shown in FIG. 5A, a case where the victim block 502 includes first to sixth valid data 510 to 560 is shown. The controller 130 performs a control to read the valid data 510 to 560 of the victim block 502. The controller 130 performs a control to read the valid data 510 to 560 from the first valid data 510 having the smallest physical address value to the sixth valid data 560 having the largest physical address value as described above with reference to FIG. 4. The controller 130 stores the read first to sixth valid data 510 to 560 in the memory 144. The controller 130 performs a control to program the first to sixth valid data 510 to 560 in the target block 504 according to the read order of the first to sixth valid data 510 to 560 within the victim block 502. According to the prior art, the controller 130 performs a control to program the first to sixth valid data 510 to 560 in the target block 504 in the order that the first to sixth valid data 510 to 560 are read from the victim block 502 (i.e., in an order of the physical addresses of the first to sixth valid data 510 to 560 within the victim block 502) without arranging the first to sixth valid data 510 to 560 in the order of the logical addresses. Accordingly, the controller 130 performs a control to program the first to sixth valid data 510 to 560 in the target block 504 in the ascending order of not the logical addresses but the physical addresses of the first to sixth valid data 510 to 560.

FIG. 5B shows a first table 506 and a second table 508 for the victim block 502 and the target block 504 respectively.

The controller 130 stores the physical-to-logical information of the victim block 502 and the target block 504 in the memory 144 in the form of the first table and the second table 508. As described above with reference to FIG. 4, the controller 130 determines the validity of data based on the logical-to-physical (L2P) information and the physical-to-logical (P2L) information. When the data stored in the victim block 502 is valid, the controller 130 stores a value of ‘1’ in the space representing the validity of the first and second tables 506 and 508.

Referring to the first table 506 shown in FIG. 5B, the victim block 502 includes first to sixth valid data 510 to 560, and the logic addresses LBA corresponding to the first to sixth valid data 510 to 560 may have the values of 5, 3, 4, 1, 2, and 0, respectively. The controller 130 performs a control to sequentially program the first to sixth valid data 510 to 560 in the target block 504 according to the order that the first to sixth valid data 510 to 560 are sequentially read from the victim block 502. Referring to the second table 508 shown in FIG. 5B, the target block 504 includes the first to sixth valid data 510 to 560, and the first to sixth valid data 510 to 560 are sorted not in the ascending order of the logical addresses LBA but in the ascending order of the physical addresses of the first to sixth valid data 510 to 560 within the victim block 502.

As the garbage collection operation of programming the valid data into the target block is repeatedly performed in the order that the valid data are read from a victim block (i.e., in an order of the physical addresses of the valid data within the victim block) according to the prior art, a fragmentation phenomenon, in which the continuity of the logical addresses of the valid data moved into a target memory block breaks, may occur. When the fragmentation occurs, the performance of the memory device 150 may deteriorate because plural pieces of data corresponding to the neighboring logical addresses are scattered and stored in various spaces within the memory device 150. For example, the performance of the sequential read operation in which data are sequentially read in a sequential order of the logical addresses may be deteriorated.

According to an embodiment of the present invention, the controller 130 may perform a control to arrange the valid data in an order, e.g., ascending order, of logical addresses and perform a garbage collection operation of programming the valid data into a target block. Accordingly, since the valid data are sorted in the order of the logical addresses in the target block as a result of the garbage collection operation, the memory space may be obtained while the fragmentation phenomenon is alleviated.

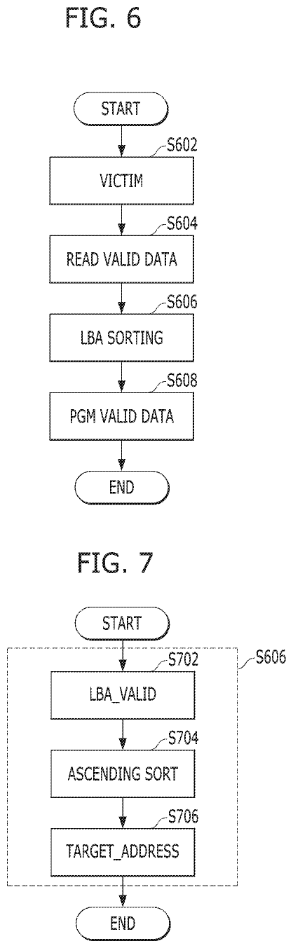

FIG. 6 is a flowchart describing an operation of the memory system 110 in accordance with an embodiment of the present invention.

In step S602, the controller 130 may detect victim blocks VICTIM among a plurality of memory blocks in the memory device 150. The controller 130 may detect the memory blocks having a number of valid pages less than a threshold value as the victim blocks VICTIM. The controller 130 may store address information on the detected victim blocks VICTIM in the memory 144. The controller 130 may perform a control to perform a check-pointing operation of periodically programming the address information on the victim blocks VICTIM into a memory block, which is a nonvolatile memory, in preparation for the occurrence of Sudden Power-Off (SPO).

In step S604, the controller 130 may perform a control to read valid data VALID DATA of the victim blocks VICTIM that are detected in the step S602. The controller 130 may perform a control to read the valid data VALID DATA stored in the victim blocks VICTIM in the ascending order of physical addresses. The controller 130 may read the valid data VALID DATA in the order from the uppermost pages to the lowermost pages among a plurality of pages included in the respective victim blocks VICTIM. The controller 130 may store the read valid data VALID DATA in the memory 144.

In step S606, the controller 130 may update address information ADDRESS such that the valid data VALID DATA that are read in the step S604 may be programmed into the target block in an order of the logical addresses LBA of the valid data VALID DATA. The address information ADDRESS may be identical to the address information TARGET_ADDRESS described later with reference to FIG. 7. According to an embodiment of the present invention, the controller 130 may refer to physical-to-logical information P2L and arrange the logical addresses LBA of the valid data VALID DATA in the ascending order. The controller 130 may update the address information ADDRESS such that the memory device 150 programs the valid data VALID DATA into the target block in the sorted order of the logical addresses LBA.

FIG. 7 is a flowchart describing an address information update operation, e.g., step S606 of FIG. 6, in detail.

In step S702, the controller 130 may check the logical addresses LBA_VALID of each valid data stored in the victim block VICTIM. The controller 130 may perform a control to read physical-to-logical information P2L on the valid data from a map data block. The controller 130 may store the logical addresses LBA_VALID of each valid data of the victim block VICTIM into the memory 144 based on the read physical-to-logical (P2L) information.

In step S704, the controller 130 may arrange the logical addresses LBA_VALID of the valid data separately stored in the victim block VICTIM in the ascending order of the logical addresses LBA_VALID. According to an embodiment of the present invention, the controller 130 may obtain a first minimum value, which is the minimum value among the candidates to be sorted, and exclude the first minimum value from the candidates after displaying the first minimum value in the first order among the candidates. Subsequently, the controller 130 may obtain a second minimum value among the candidates excluding the first minimum value and may exclude the second minimum value from the candidates after displaying the second minimum value in the second order of the candidates. The controller 130 may repeatedly perform the above-described operation to sort out the candidates to be sorted in the ascending order of the logical addresses. This scheme is merely exemplary. Other known schemes to sort or arrange the logical addresses of the valid data.

In step S706, the controller 130 may update the address information TARGET_ADDRESS such that valid data may be programmed in a target block in the order of the arranged logical addresses LBA_VALID of the valid data. The controller 130 may provide the memory device 150 with the updated address information TARGET_ADDRESS and the corresponding valid data. According to an embodiment of the present invention, the controller 130 may control the memory device 150 to perform a garbage collection operation by programming the valid data in the target block based on the updated address information TARGET_ADDRESS. Therefore, the controller 130 may store the valid data in the order of the logical addresses LBA_VALID of the valid data while obtaining the memory space.

Referring back to step S608 of FIG. 6, the controller 130 may control the memory device 150 to program the valid data VALID DATA into the target block based on the address information ADDRESS which is updated in the step S606. According to an embodiment of the present invention, the controller 130 may control the memory device 150 to program the valid data VALID DATA of the victim block into the target block in the order of the logical addresses LBA of the valid data so that deterioration of the fragmentation phenomenon due to a garbage collection operation may be minimized. In this way, the sequential read performance may be improved.

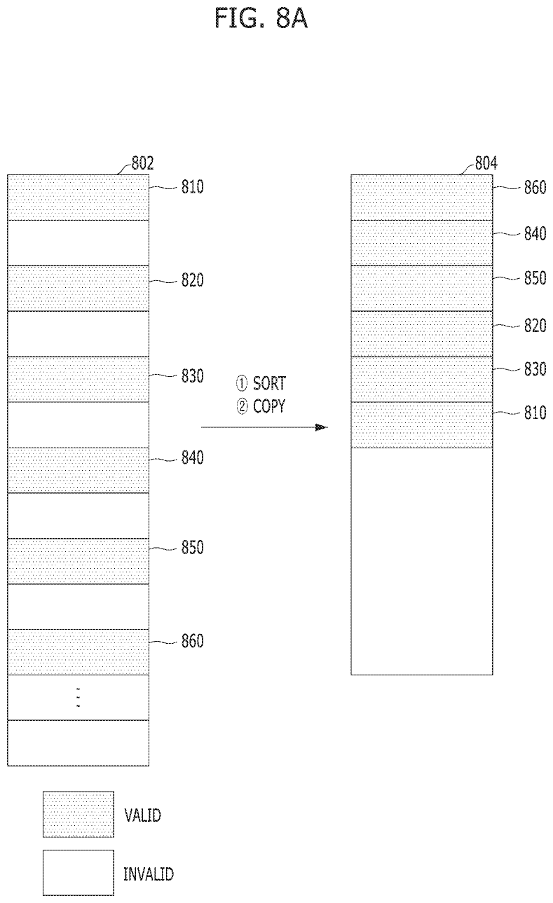

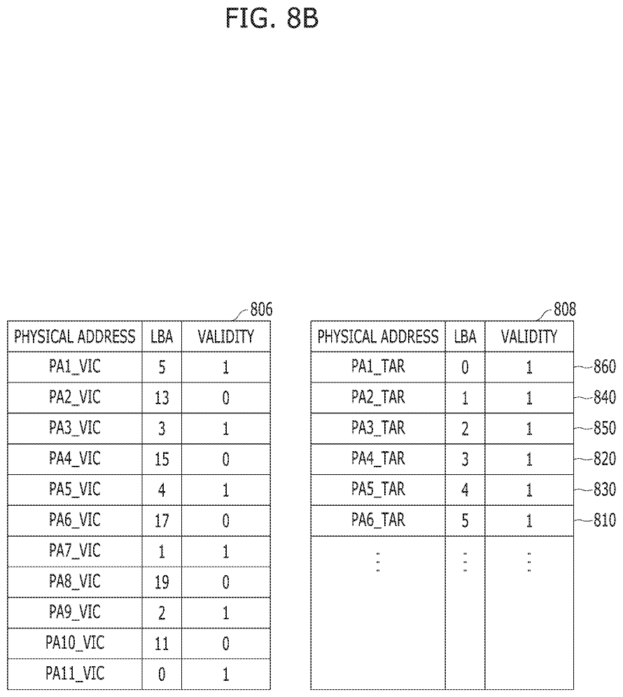

FIGS. 8A and 8B illustrate an operation of programming valid data in accordance with an embodiment of the present invention.

The controller 130 may determine the validity of the data of the victim block 802 by referring to a first table 806 in which physical-to-logical information on the victim block 802 is recorded as shown in FIG. 8B. The controller 130 may store the logical addresses LBA of the first to sixth valid data 810 to 860 in a separate space and then arrange the logical addresses LBA in the order. For example, the controller 130 may arrange the logical addresses LBA 5, 3, 4, 1, 2, and 0 of the first to sixth valid data 810 to 860 into an ascending order (i.e., 0 to 5). The controller 130 may control the memory device 150 to program the first to sixth valid data 810 to 860 into a target block 804 in the arranged order (e.g., ascending order 0 to 5) of the logical addresses LBA.

As illustrated in FIG. 8A, the controller 130 may perform a control to sequentially program sixth valid data 860, fourth valid data 840, fifth valid data 850, second valid data 820, third valid data 830, and first valid data 810, which respectively correspond to the logical addresses LBA having values of 0 to 5, into the target block. As shown in a second table 808 in which the physical-to-logical information for the target block 804 shown in FIG. 8B is recorded, the first to sixth valid data 810 to 860 may be stored in a target block 808 in the arranged order of the logical addresses LBA of the valid data 810 to 860.

FIG. 9 is a block diagram illustrating the memory system 110 in accordance with an embodiment of the present invention. FIG. 9 schematically shows only the constituent elements related to the present invention in the data processing system 100 of FIG. 1.

The processor 134 described earlier with reference to FIG. 1 may include the victim block detector 902, a valid data manager 904, an address updater 906, and a garbage collection module 908.

The victim block detector 902 may detect victim blocks VICTIM among a plurality of memory blocks in the memory device 150. The victim block detector 902 may detect memory blocks whose number of valid pages is less than a threshold value as the victim block VICTIM based on the physical-to-logical address information P2L and the logical-to-physical address information L2P. The victim block detector 902 may provide the valid data manager 904 with information INFO_VICTIM on the detected victim blocks VICTIM.

According to an embodiment of the present invention, the victim block detection unit 902 may search the physical-to-logical address information P2L for a logical address corresponding to an actual physical address indicating where specific data stored in a memory block in order to determine the validity of the specific data, and search the logical-to-physical address information L2P for a nominal physical address corresponding to the logical address detected from the physical-to-logical address information P2L. When the nominal physical address detected from the logical-to-physical address information L2P coincides with the actual physical address at which the specific data is stored in the memory block, the victim block detector 902 may determine the data as valid data. A page storing the data determined as valid is a valid page.

The valid data manager 904 may control the memory device 150 to read the valid data of the detected victim blocks VICTIM based on the provided victim block information INFO_VICTIM. The valid data manager 904 may search for the valid pages storing the valid data among a plurality of pages of the victim blocks VICTIM. The valid data manager 904 may perform a control to read the valid data stored in the searched valid pages in the ascending order of the physical addresses, that is, in the order of the uppermost page to the lowermost page within each of the victim blocks VICTIM. The valid data manager 904 may provide the address updater 906 with valid data information INFO_VALID on the valid data.

The address updater 906 may update the address information INFO_ADDRESS such that the valid data are programmed in a target block in the ascending order of the logical addresses of the valid data. The address updater 906 may search the logical addresses of the valid data read from the victim blocks VICTIM by referring to the physical-to-logical address information P2L. The address updater 906 may arrange the searched logical addresses in an order and update the address information INFO_ADDRESS so that the valid data are programmed in the target block according to the arranged order of the logical addresses of the valid data. The address updater 906 may provide the garbage collection module 908 with the updated address information INFO_ADDRESS.

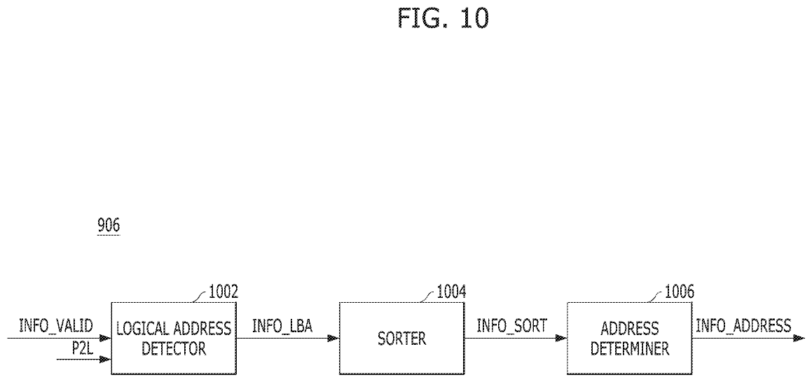

FIG. 10 is a block diagram illustrating the address updater 906 in detail.

The address updater 906 may include a logical address detector 1002, a sorter 1004, and an address determiner 1006.

The logical address detector 1002 may detect the logical addresses of the valid data based on the valid data information INFO_VALID and the physical-to-logical address information P2L. The logical address detector 1002 may detect the logical addresses corresponding to the physical addresses of the valid data read from the victim blocks VICTIM by referring to the physical-to-logical address information P2L. The logical address detector 1002 may provide the sorter 1004 with valid data information INFO_LBA on the logical addresses of the valid data read from the victim blocks VICTIM.

The sorter 1004 may arrange the detected logical addresses of the valid data in the ascending order based on the provided valid data logical address information INFO_LBA. The sorter 1004 may provide the address determiner 1006 with sorting information INFO_SORT on the arranged logical addresses of the valid data.

The address determiner 1006 may update the address information INFO_ADDRESS so that the memory device 150 may sequentially program the valid data according to the arranged order of the logical addresses in a target block based on the provided logical address sorting information INFO_SORT. For example, the address determiner 1006 may update the address information INFO_ADDRESS so that the valid data are programmed sequentially from a uppermost page to the lowermost page within the target block according to the ascending order of the logical addresses. The address determiner 1006 may provide the garbage collection module 908 with the updated address information INFO_ADDRESS.

Referring back to FIG. 9, the garbage collection module 908 may control the memory device 150 to program the valid data into the target block according to the provided address information INFO_ADDRESS representing the arranged order of the logical addresses of the valid data. According to an embodiment of the present invention, the garbage collection module 908 may control the memory device 150 to program the valid data into the target block in the arranged order of the logical addresses so that the fragmentation phenomenon and resulting deterioration due to a garbage collection operation may be minimized. As the fragmentation phenomenon is minimized, plural pieces of data corresponding to the neighboring logical addresses may be stored to be concentrated into the neighboring space of the memory device 150. Therefore, according to an embodiment of the present invention, the garbage collection module 908 may perform a garbage collection operation of programming the target block in the arranged order of logical addresses. As a result, not only the memory space is obtained but also the performance of a sequential-read operation of sequentially performing a read operation in the order of the logical addresses may be improved.

A memory device in a memory system in accordance with an embodiment of the present invention will be described in more detail with reference to FIGS. 11 to 13.

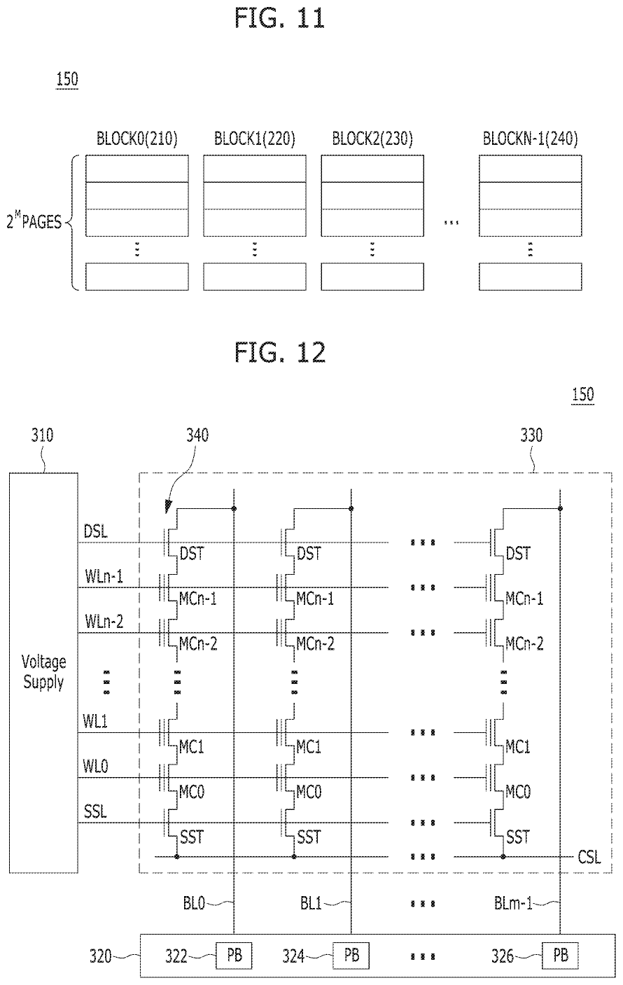

FIG. 11 is a schematic diagram illustrating an exemplary block configuration of the memory device 150. FIG. 12 is a circuit diagram illustrating an exemplary configuration of a memory cell array of a memory block 330 in the memory device 150. FIG. 13 is a schematic diagram illustrating an exemplary 3D structure of the memory device 150.

Referring to FIG. 11, the memory device 150 may include a plurality of memory blocks BL0CKO to BL0CKN−1, where N is an integer greater than 1. Each of the blocks BL0CKO to BL0CKN−1 may include a plurality of pages, for example, 2^{M} or M pages, the number of which may vary according to circuit design, M being an integer greater than 1. Each of the pages may include a plurality of memory cells that are coupled to a plurality of word lines WL.

Also, each of the memory blocks BL0CKO to BL0CKN−1 may include memory cells, each of which may be a single level cell (SLC) storing 1-bit data or a multi-level cell (MLC) storing 2-bit data. Hence, the memory device 150 may include SLC memory blocks or MLC memory blocks, depending on the number of bits which can be expressed or stored in each of the memory cells in the memory blocks. The SLC memory blocks may include a plurality of pages which are embodied by memory cells, each storing one-bit data. The SLC memory blocks may generally have higher data computing performance and higher durability than the MLC memory blocks. The MLC memory blocks may include a plurality of pages which are embodied by memory cells each storing multi-bit data (for example, 2 or more bits). The MLC memory blocks may generally have larger data storage space, that is, higher integration density, than the SLC memory blocks. In another embodiment, the memory device 150 may include a plurality of triple level cell (TLC) memory blocks. In yet another embodiment, the memory device 150 may include a plurality of quadruple level cell (QLC) memory blocks. The TCL memory blocks may include a plurality of pages which are embodied by memory cells each capable of storing 3-bit data. The QLC memory blocks may include a plurality of pages which are embodied by memory cells each capable of storing 4-bit data.

Instead of a nonvolatile memory, the memory device 150 may be implemented by any of a phase change random access memory (PCRAM), a resistive random access memory (RRAM(ReRAM)), a ferroelectrics random access memory (FRAM), and a spin transfer torque magnetic random access memory (STT-RAM(STT-MRAM)).

The memory blocks 210, 220, 230, 240 may store the data transferred from the host 102 through a program operation, and may transfer data stored therein to the host 102 through a read operation.

Referring to FIG. 12, the memory block 330 may include a plurality of cell strings 340 coupled to a plurality of corresponding bit lines BL0 to BLm−1. The cell string 340 of each column may include one or more drain select transistors DST and one or more source select transistors SST. Between the drain and source select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 13, the first cell string is coupled to the first bit line BL0, and the last cell string is coupled to the last bit line BLm−1.

Although FIG. 12 illustrates NAND flash memory cells, the present disclosure is not limited thereto. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which generates different word line voltages including a program voltage, a read voltage, and a pass voltage to supply to the word lines according to an operation mode. The voltage generation operation of the voltage supply 310 may be controlled by a control circuit (not illustrated). Under the control of the control circuit, the voltage supply 310 may select at least one of the memory blocks (or sectors) of the memory cell array, select at least one of the word lines of the selected memory block, and provide the word line voltages to the selected word line(s) and the unselected word lines as may be needed.

The memory device 150 may include a read/write circuit 320 which is controlled by the control circuit. During a verification/normal read operation, the read/write circuit 320 may operate as a sense amplifier for reading (sensing and amplifying) data from the memory cell array. During a program operation, the read/write circuit 320 may operate as a write driver for supplying a voltage or a current to bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

The memory device 150 may be embodied by a 2D or 3D memory device. Particularly, as illustrated in FIG. 13, the memory device 150 may be embodied by a nonvolatile memory device having a 3D stack structure. When the memory device 150 has a 3D structure, the memory device 150 may include a plurality of 3D memory blocks BLK0 to BLKN−1, which may correspond to the memory blocks 152, 154 and 156 shown in FIG. 1. Each of the memory blocks 152, 154 and 156 may be realized in a 3D structure (or vertical structure). For example, the memory blocks 152, 154 and 156 may form a three-dimensional structure with dimensions extending in first to third mutually orthogonal directions, e.g., an x-axis direction, a y-axis direction, and a z-axis direction.

Each memory block 330 included in the memory device 150 may include a plurality of NAND strings NS that are extended in the second direction, and a plurality of NAND strings NS that are extended in the first direction and the third direction. Herein, each of the NAND strings NS may be coupled to a bit line BL, at least one string selection line SSL, at least one ground selection line GSL, a plurality of word lines WL, at least one dummy word line DWL, and a common source line CSL, and each of the NAND strings NS may include a plurality of transistor structures TS.

In short, each memory block 330 among the memory blocks 152, 154 and 156 of the memory device 150 may be coupled to a plurality of bit lines BL, a plurality of string selection lines SSL, a plurality of ground selection lines GSL, a plurality of word lines WL, a plurality of dummy word lines DWL, and a plurality of common source lines CSL, and each memory block 330 may include a plurality of NAND strings NS. Also, in each memory block 330, one bit line BL may be coupled to a plurality of NAND strings NS to realize a plurality of transistors in one NAND string NS. Also, a string selection transistor SST of each NAND string NS may be coupled to a corresponding bit line BL, and a ground selection transistor GST of each NAND string NS may be coupled to a common source line CSL. Herein, memory cells MC may be provided between the string selection transistor SST and the ground selection transistor GST of each NAND string NS. In other words, a plurality of memory cells may be realized in each memory block 330 of the memory blocks 152, 154 and 156 of the memory device 150.

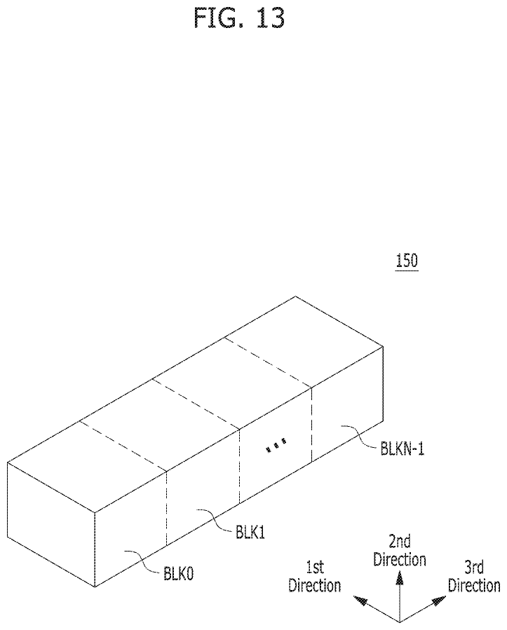

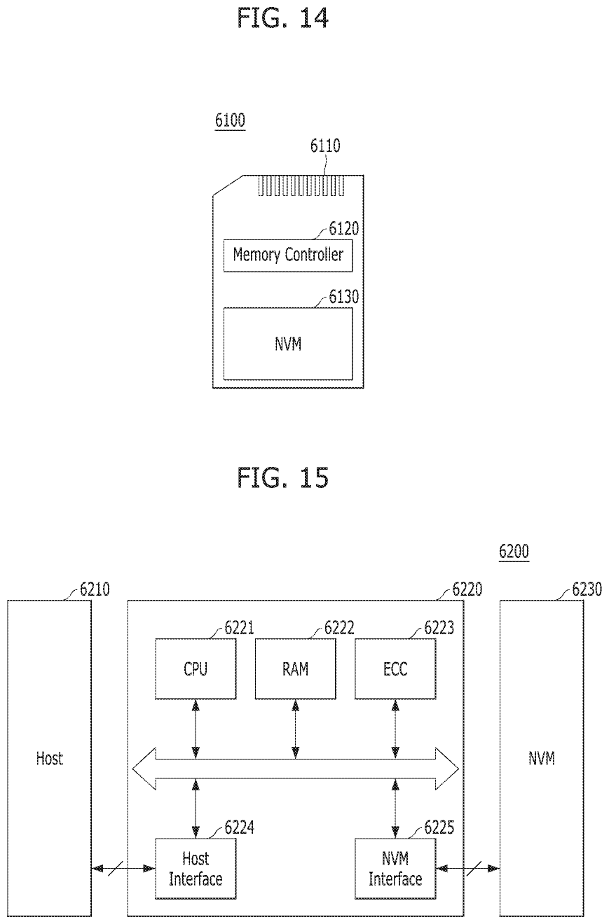

A data processing system and electronic devices, to which the memory system 110 including the memory device 150 and the controller 130 described above may be applied, in accordance with embodiments of the present invention, are described in detail below with reference to FIGS. 14 to 22.

FIG. 14 is a diagram schematically illustrating another example of the data processing system including the memory system in accordance with an embodiment. FIG. 14 schematically illustrates a memory card system to which the memory system may be applied.

Referring to FIG. 14, the memory card system 6100 may include a memory controller 6120, a memory device 6130 and a connector 6110.

More specifically, the memory controller 6120 may be electrically connected to, and configured to access, the memory device 6130 embodied by a nonvolatile memory. For example, the memory controller 6120 may be configured to control read, write, erase and background operations of the memory device 6130. The memory controller 6120 may be configured to provide an interface between the memory device 6130 and a host, and to use firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, the memory controller 6120 may include a RAM, a processor, a host interface, a memory interface and an error correction component.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols, such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with an embodiment may be applied to wired/wireless electronic devices including mobile electronic devices.

The memory device 6130 may be implemented by a nonvolatile memory. For example, the memory device 6130 may be implemented by any of various nonvolatile memory devices, such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device to form a solid-state driver (SSD). Also, the memory controller 6120 and the memory device 6130 may be so integrated to form a memory card, such as a PC card (PCMCIA: Personal Computer Memory Card International Association), a compact flash (CF) card, a smart media card (e.g., a SM and a SMC), a memory stick, a multimedia card (e.g., a MMC, a RS-MMC, a MMCmicro and an eMMC), an SD card (e.g., a SD, a miniSD, a microSD and a SDHC), and/or a universal flash storage (UFS).

FIG. 15 is a diagram schematically illustrating another example of the data processing system including the memory system in accordance with an embodiment.

Referring to FIG. 15, the data processing system 6200 may include a memory device 6230 having one or more nonvolatile memories and a memory controller 6220 for controlling the memory device 6230. The data processing system 6200 illustrated in FIG. 15 may serve as a storage medium such as a memory card (CF, SD, micro-SD or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210. The memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or vice versa. When the RAM 6222 is used as a cache memory, the RAM 6222 may assist the low-speed memory device 6230 to operate at high speed.

The ECC circuit 6223 may generate an ECC (Error Correction Code) for correcting a failed bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. The ECC circuit 6223 may correct an error using the LDPC code, BCH code, turbo code, Reed-Solomon code, convolution code, RSC or coded modulation such as TCM or BCM.

The memory controller 6220 may exchange data with the host 6210 through the host interface 6224. The memory controller 6220 may exchange data with the memory device 6230 through the NVM interface 6225. The host interface 6224 may be connected to the host 6210 through a PATA bus, a SATA bus, a SCSI, an USB, a PCIe or a NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device according to one or more of various communication protocols, the memory system and the data processing system in accordance with an embodiment may be applied to wired/wireless electronic devices, particularly a mobile electronic device.

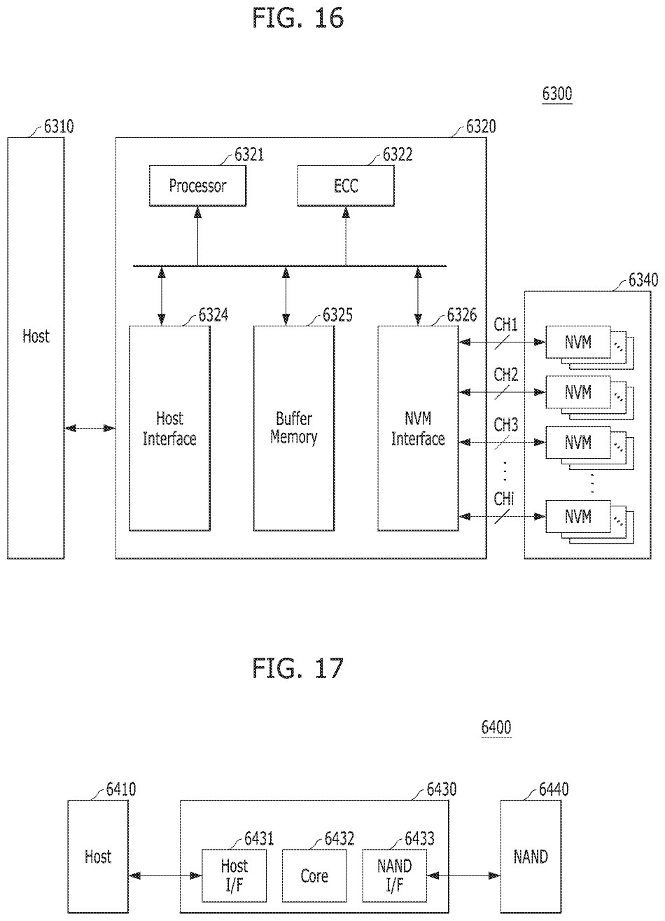

FIG. 16 is a diagram schematically illustrating another example of the data processing system including the memory system in accordance with an embodiment. FIG. 16 schematically illustrates an SSD to which the memory system may be applied.

Referring to FIG. 16, the SSD 6300 may include a controller 6320 and a memory device 6340 including a plurality of nonvolatile memories. The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340. Further, the buffer memory 6325 may temporarily store meta data of the plurality of flash memories NVM, for example, map data including a mapping table. The buffer memory 6325 may be embodied by any of a variety of volatile memories, such as a DRAM, a SDRAM, a DDR SDRAM, a LPDDR SDRAM and a GRAM or nonvolatile memories such as a FRAM, a ReRAM, a STT-MRAM and a PRAM. FIG. 16 illustrates that the buffer memory 6325 is embodied in the controller 6320. However, the buffer memory 6325 may be external to the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 may be applied may be provided to embody a data processing system, for example, a RAID (Redundant Array of Independent Disks) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 17 is a diagram schematically illustrating another example of the data processing system including the memory system in accordance with an embodiment. FIG. 17 schematically illustrates an embedded Multi-Media Card (eMMC) to which the memory system may be applied.

Referring to FIG. 17, the eMMC 6400 may include a controller 6430 and a memory device 6440 embodied by one or more NAND flash memories. The controller 6430 may correspond to the controller 130 in the memory system 110 of FIG. 1. The memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

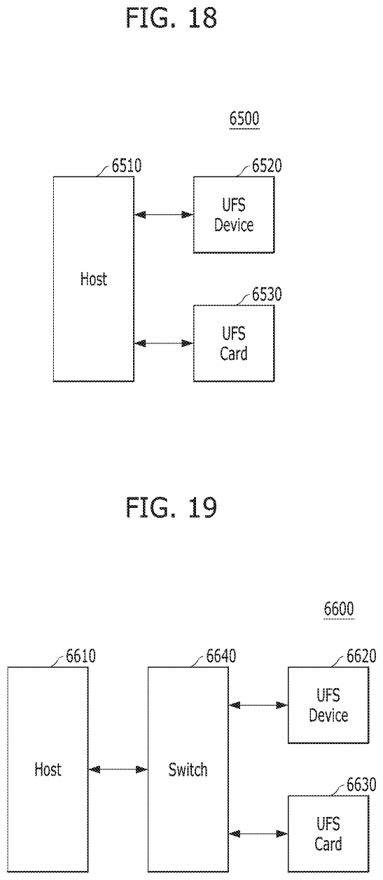

FIGS. 18 to 21 are diagrams schematically illustrating other examples of the data processing system including the memory system in accordance with embodiments. FIGS. 18 to 21 schematically illustrate UFS (Universal Flash Storage) systems to which the memory system may be applied.

Referring to FIGS. 18 to 21, the UFS systems 6500, 6600, 6700, 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices or particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices, for example, wired/wireless electronic devices or particularly mobile electronic devices through UFS protocols, and the UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 15 to 17, and the UFS cards 6530, 6630, 6730, 6830 may be embodied in the form of the memory card system 6100 described with reference to FIG. 14.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through any of various protocols other than the UFS protocol, for example, an UFDs, a MMC, a SD, a mini-SD, and a micro-SD.

In the UFS system 6500 illustrated in FIG. 18, each of the host 6510, the UFS device 6520 and the UFS card 6530 may include UniPro. The host 6510 may perform a switching operation to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In the illustrated embodiment, one UFS device 6520 and one UFS card 6530 are connected to the host 6510. However, in another embodiment, a plurality of UFS devices and UFS cards may be connected in parallel or in the form of a star to the host 6410. A star formation is an arrangement in which a single device is coupled with plural devices for centralized operation. A plurality of UFS cards may be connected in parallel or in the form of a star to the UFS device 6520 or connected in series or in the form of a chain to the UFS device 6520.

In the UFS system 6600 illustrated in FIG. 19, each of the host 6610, the UFS device 6620 and the UFS card 6630 may include UniPro. The host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the illustrated embodiment, one UFS device 6620 and one UFS card 6630 are connected to the switching module 6640. However, in another embodiment, a plurality of UFS devices and UFS cards may be connected in parallel or in the form of a star to the switching module 6640. A plurality of UFS cards may be connected in series or in the form of a chain to the UFS device 6620.

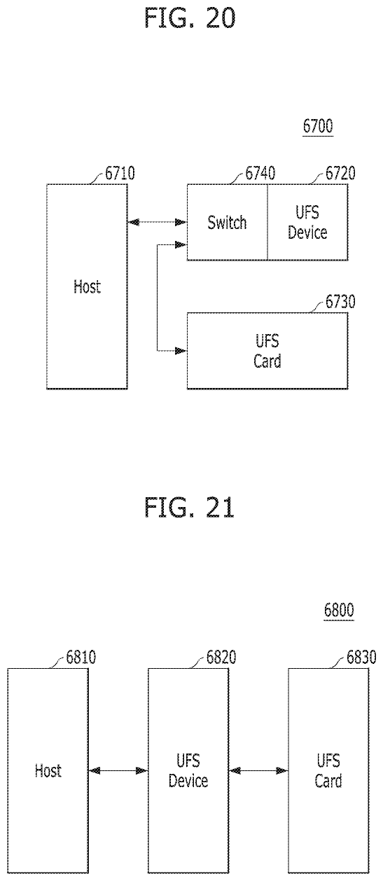

In the UFS system 6700 illustrated in FIG. 20, each of the host 6710, the UFS device 6720 and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro. The switching module 6740 may be integrated as one module with the UFS device 6720 within or externally to the UFS device 6720. In the illustrated embodiment, one UFS device 6720 and one UFS card 6730 are connected to the switching module 6740. However, in another embodiment, a plurality of modules, each including the switching module 6740 and the UFS device 6720, may be connected in parallel or in the form of a star to the host 6710. In another example, a plurality of modules may be connected in series or in the form of a chain to each other. Furthermore, a plurality of UFS cards may be connected in parallel or in the form of a star to the UFS device 6720.

In the UFS system 6800 illustrated in FIG. 21, each of the host 6810, the UFS device 6820 and the UFS card 6830 may include M-PHY and UniPro. The UFS device 6820 may perform a switching operation to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. The host 6810 and the UFS card 6830 may communicate with each other through target ID switching between the M-PHY and UniPro modules of the UFS device 6820. In the illustrated embodiment, one UFS device 6820 is connected to the host 6810 and one UFS card 6830 is connected to the UFS device 6820. However, in another embodiment, a plurality of UFS devices may be connected in parallel or in the form of a star to the host 6810, or connected in series or in the form of a chain to the host 6810. A plurality of UFS cards may be connected in parallel or in the form of a star to the UFS device 6820, or connected in series or in the form of a chain to the UFS device 6820.

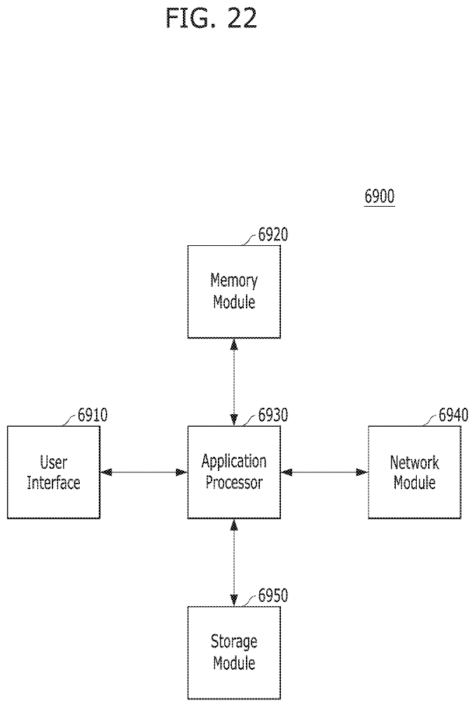

FIG. 22 is a diagram schematically illustrating another example of the data processing system including the memory system in accordance with an embodiment of the present invention. FIG. 22 is a diagram schematically illustrating a user system to which the memory system may be applied.

Referring to FIG. 22, the user system 6900 may include an application processor 6930, a memory module 6920, a network module 6940, a storage module 6950 and a user interface 6910.

More specifically, the application processor 6930 may drive components in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM, such as a DRAM, a SDRAM, a DDR SDRAM, a DDR2 SDRAM, a DDR3 SDRAM, a LPDDR SDARM, a LPDDR3 SDRAM or a LPDDR3 SDRAM or a nonvolatile RAM such as a PRAM, a ReRAM, a MRAM or a FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices, particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, a NOR flash and a 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, an eMMC and an UFS as described above with reference to FIGS. 16 to 21.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

According to embodiments of the present invention, a memory system may not only obtain a memory space by performing a garbage collection operation but also arrange the valid data stored in a memory block in an order of logical addresses.

While the present invention has been illustrated and described with respect to the specific embodiments, it will be apparent to those skilled in the art that various changes and modifications may be made without departing from the spirit and scope of the invention as defined in the following claims.

What is claimed is:

1. A memory system, comprising:
a memory device;
a logical address detector suitable for detecting logical addresses corresponding to physical addresses of valid data stored in a victim block based on physical-to-logical address information;
a sorter suitable for arranging the detected logical addresses in a specific order; and
a garbage collection module suitable for controlling the memory device to perform a garbage collection operation by sequentially programming the valid data into a target block according to the arranged logical addresses.

2. The memory system of claim 1, further comprising: an address updater suitable for updating address information of the valid data based on the arranged logical addresses such that the valid data are programmed into the target block in the specific order of the logical addresses.

3. The memory system of claim 1, further comprising: a victim block detector suitable for detecting as the victim block a memory block having a number of valid pages less than a threshold value, among memory blocks included in the memory device.

4. The memory system of claim 1, further comprising: a valid data manager suitable for controlling the memory device to read the valid data from the victim block.

5. The memory system of claim 4,
wherein the valid data manager determines data stored in the victim memory block to be the valid data when an actual physical address of the data is the same as a nominal physical address corresponding to a logical address within logical-to-physical information, the logical address corresponding to the actual physical address within the physical-to-logical information.

6. The memory system of claim 1, wherein the physical-to-logical information indicates a relationship between a logical address and the actual physical address of data.

7. The memory system of claim 5, wherein the logical-to-physical information indicates a relationship between the nominal physical address, which is recently updated, and the logical address of data.

8. The memory system of claim 1, wherein the sorter arranges the logical addresses in an ascending order, as the specific order.

9. The memory system of claim 1, wherein the target block is a block having a number of blank pages equal to or greater than a threshold value.

10. The memory system of claim 4, wherein the valid data manager reads the valid data in an ascending order of corresponding physical addresses.

11. A method for operating a memory system, comprising:
detecting logical addresses corresponding to physical addresses of valid data stored in a victim block based on physical-to-logical address information;
arranging the detected logical addresses in a specific order; and
performing a garbage collection operation by sequentially programming the valid data into a target block according to the arranged logical addresses.

12. The method of claim 11, further comprising: updating address information of the valid data based on the arranged logical addresses such that the valid data are programmed into the target block in the specific order of the logical addresses.

13. The method of claim 11, further comprising: detecting as the victim block a memory block having a number of valid pages less than a threshold value, among the memory blocks included in the memory device.

14. The method of claim 11, further comprising:
reading the valid data from the victim block.

15. The method of claim 14, wherein the reading of the valid data includes determining data stored in the victim memory block as the valid data when an actual physical address of the data is the same as a nominal physical address corresponding to a logical address within logical-to-physical information, the logical address corresponding to the actual physical address within the physical-to-logical information.

16. The method of claim 11, wherein the physical-to-logical information indicates a relationship between a logical address and the actual physical address of data.

17. The method of claim 15, wherein the logical-to-physical information indicates a relationship between the nominal physical address, which is recently updated, and the logical address of data.

18. The method of claim 11, wherein the logical addresses are arranged in an ascending order, as the specific order.

19. The method of claim 11, wherein the target block is a block having a number of blank pages equal to or greater than a threshold value.

20. The method of claim 14, wherein the valid data are read from the victim block in an ascending order of corresponding physical addresses.
